(19) United States
(12) Patent Application Publication
(10) Pub. No.: US 2008/0301590 A1
(43) Pub. Date: Dec. 4, 2008

(54) NAVIGATION OF A DIRECTORY STRUCTURE

(75) Inventors: Christian Ostergaard, Vaerlose (DK); Franco Montebovi, Lund (SE)

Correspondence Address: PERMAN & GREEN, 425 POST ROAD, FAIRFIELD, CT, 06824, US

(73) Assignee: NOKIA CORPORATION, Espoo (FI)

(21) Appl. No.: 12/112,207

(22) Filed: Apr. 30, 2008

Related U.S. Application Data
(60) Provisional application No. 60/915,222, filed on May 1, 2007.

(51) Int. Cl. G06F 3/048

(52) U.S. Cl. 715/853

(57) ABSTRACT

A user interface for navigating a directory structure includes a first screen area for showing a directory path to a currently identified target location and a second screen area for showing the contents of a currently identified target location, a user control having a plurality of predetermined modes of actuation, there being at least one predetermined mode for navigating within an area, and at least one predetermined mode for navigating between the areas. The user interface allows the user to navigate the directory structure, and operate on the contents, using a conveniently small number of inputs.

### CROSS-REFERENCE TO RELATED APPLICATIONS

This application claims priority to, and the benefit of, U.S. Provisional Patent Application Ser. No. 60/915,222, filed on May 1, 2007, the disclosure of which is incorporated herein by reference in its entirety.

### FIELD

The disclosed embodiments relate to directory structures such as for a memory used for storing files in a device. In particular, they relate to a method, computer program product and device for providing user navigation of a directory structure.

### BACKGROUND

In many types of electronic device, files are stored in memory. Files may include data, images, sound, music or other information. Files may be stored in a directory structure for ease of subsequent location when needed. The directory structure may become increasingly complex as the number of stored files increases. This can increase the difficulty experienced by a user when navigating around the directory structure to locate a file, particularly if only a limited range of user controls is available, as may be the case with a small hand-held portable device such as a mobile telephone, or if the display is small, so that the information available to the user is limited, again as in the case of a hand-held device such as a mobile telephone.

### BRIEF DESCRIPTION OF THE DISCLOSED EMBODIMENTS

According to one embodiment, an apparatus is configured to store files in a directory structure, and comprises a user interface including a display and at least one user control, the user interface being configured to receive user instructions to navigate around the directory structure to identify target files and target locations, and wherein, during navigation by a user, the user interface provides at least a first screen area for showing a directory path to a currently identified target location, and a second screen area for showing the contents of a currently identified target location, wherein the user control has a plurality of predetermined modes of actuation, there being at least one predetermined mode of actuation for navigating within a said area, and at least one predetermined mode of actuation for navigating between said areas.

The first screen area, in use, may display a directory path as a list of locations in hierarchical order. The second screen area, in use, may display the contents as a list. The list may be suppressed when a user navigates away from the currently defined target location. The contents may be identified by file names or by meta data associated with the contents. One or more locations of the directory structure may be restricted to containing contents having predetermined attributes. Navigation destinations may be selected in accordance with meta data associated with the contents.

Respective predetermined modes of actuation may provide for navigation up and down a list. The Up and Down modes may be provided by respective modes of actuation of a multi-mode control member. A further predetermined mode of actuation may provide for selection of a location as the currently identified location. The Selection mode may be a further mode of actuation of a multi-mode control member.

The interface may be responsive to the selection of a new location for refreshing the contents shown in the second area.

The user interface may be operable to modify the appearance of the said areas. The appearance may be modified by providing differential brightness. The appearance may be modified in order to indicate which of the said areas is currently active. The sizes, or relative sizes, of the first and second screen areas may be dynamic. A directory path shown in the first screen area may be truncated in the event that the size of the first screen area is reduced. The directory path may be truncated by omitting higher order information.

At least one further predetermined mode of actuation may be provided for navigation between the areas. Respective further predetermined modes may be provided for navigation in respective senses between the areas. The respective further predetermined modes may be provided by respective modes of actuation of a multi-mode control member.

When a user has navigated to a file, a still further predetermined mode of actuation may provide for at least one operation to be performed on the said file. The still further mode may provide for the said file to be moved to another location. The user interface may be operable to receive an instruction identifying the another location by means of user actuation for navigation within and between said areas.

A still further predetermined mode may call a menu of operations for selection by the user. The menu may include one, or more than one of the following operations: move the file, delete the file, copy the file, send the file, open the file, rename the file, edit meta data and exit the menu. The menu may include one or more than one of the following operations: view the file contents, play the file contents, load the file, such as by streaming, and bookmark the file. The menu may include an operation to move or copy a file in accordance with meta data associated with the file. The still further predetermined mode may be provided by a soft key, only when a user has navigated to a file.

An additional predetermined mode of actuation may be provided for the currently identified target location to be replaced as the target location by a location at a different level of the hierarchy, such as a higher level. The additional predetermined mode may be provided by a soft key.

At least some of the predetermined modes of actuation are provided by a joystick having modes of Up, Down, Left, Right and Depress.

The said areas may be provided by visually dividing the display horizontally or vertically. The orientation may be dependent on the orientation of the device. The sizes of the areas may be fixed or dynamic.

According to another embodiment a method comprises providing at least one user control having a plurality of predetermined modes of actuation, receiving user instructions to navigate around a directory structure storing files in a device, to identify target files and target locations, and wherein, at least a first screen area is provided for showing a directory path to a currently identified target location, and a second screen area is provided for showing the contents of a currently identified target location, and wherein at least one predetermined mode of actuation results in navigation within a said area, and at least one predetermined mode of actuation results in navigation between said areas.

The first screen area may display a directory path as a list of locations in hierarchical order. The second screen area may display the contents as a list. The list may be suppressed when a user navigates away from the currently defined target location. The contents may be identified by file names or by meta data associated with the contents. One or more locations of the directory structure may be restricted to containing contents having predetermined attributes. Navigation destinations may be selected in accordance with meta data associated with the contents.

Respective predetermined modes of actuation may provide for navigation up and down a list. The Up and Down modes may be provided by respective modes of actuation of a multi-mode control member.

A further predetermined mode of actuation may provide for selection of a location as the currently identified location. The Selection mode may be a further mode of actuation of a multi-mode control member. The interface may be responsive to the selection of a new location for refreshing the contents shown in the second area.

The user interface may be operable to modify the appearance of the said areas. The appearance may be modified by providing differential brightness. The appearance may be modified in order to indicate which of the said areas is currently active. The sizes, or relative sizes, of the first and second screen areas may be dynamic. A directory path shown in the first screen area may be truncated in the event that the size of the first screen area is reduced. The directory path may be truncated by omitting higher order information.

At least one further predetermined mode of actuation may be provided for navigation between the areas. Respective further predetermined modes may be provided for navigation in respective senses between the areas. The respective further predetermined modes may be provided by respective modes of actuation of a multi-mode control member.

When a user has navigated to a file, a still further predetermined mode of actuation may be provided for at least one operation to be performed on the said file. The still further mode may provide for the said file to be moved to another location. The user interface may be operable to receive an instruction identifying the another location by means of user actuation for navigation within and between said areas. The still further predetermined mode may call a menu of operations for selection by the user. The menu may include one, or more than one of the following operations: move the file, delete the file, copy the file, send the file, open the file, rename the file, edit meta data and exit the menu. The menu may include one or more than one of the following operations: view the file contents, play the file contents, load the file, such as by streaming, and bookmark the file. The menu may include an operation to move or copy a file in accordance with meta data associated with the file. The still further predetermined mode may be provided by a soft key, only when a user has navigated to a file.

An additional predetermined mode of actuation may provide for the currently identified target location to be replaced as the target location by a location at a different level of the hierarchy, such as a higher level. The additional predetermined mode may be provided by a soft key.

At least some of the predetermined modes of actuation are provided by a navikey having modes of Up, Down, Left, Right and Depress.

The said areas may be provided by visually dividing the display horizontally or vertically. The orientation may be dependent on the orientation of the device. The sizes of the areas may be fixed or dynamic.

According to another embodiment there is provided a computer program product comprising program instructions stored in a memory for receiving user instructions by actuation of a user control having a plurality of predetermined modes of actuation, to navigate around a directory structure storing files in a device, to identify target files and target locations, and to provide a first area on a screen for showing a directory path to a currently identified target location, and a second area on the or a screen for showing the contents of the currently identified target location, and wherein at least one predetermined mode of actuation results in navigation within a said area, and at least one predetermined mode of actuation results in navigation between said areas.

### BRIEF DESCRIPTION OF THE DRAWINGS

Examples of the disclosed embodiments will now be described in more detail, by reference to the accompanying drawings, in which:

FIG. 1 schematically illustrates an electronic communications device;

FIG. 2 schematically illustrates the outer appearance of the device of FIG. 1;

FIG. 3 schematically illustrates an example of a directory structure used for file storage within the memory of the device of FIG. 1; and

FIGS. 4a-4h, 5a-5d, 6a-6g and 7a-7f are screen images from the device of FIG. 2, at various states of operation.

### DETAILED DESCRIPTION OF THE EMBODIMENTS

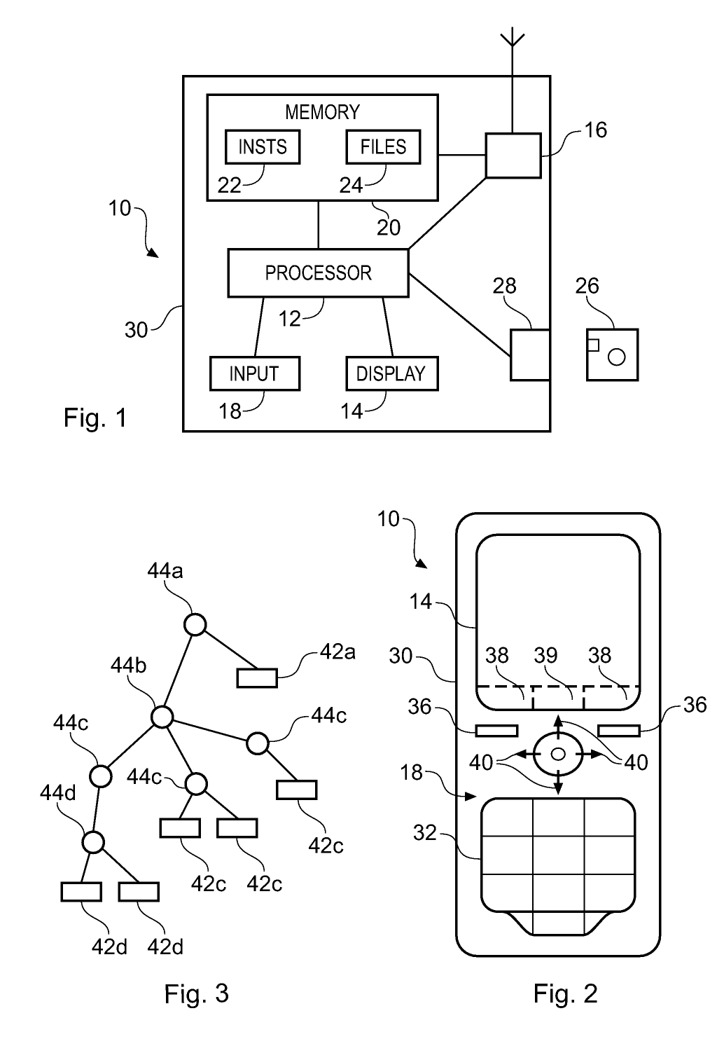

FIG. 1 schematically illustrates a device 10 which, in this example, is an electronic communications device and comprises a processor 12, a memory 20, a user input device 18, a display 14 and a communications interface 16. In this example, the communications interface 16 is a cellular radio transceiver enabling the electronic communications device 10 to operate in a mobile cellular telecommunications network. The memory 20 is used for storing computer program instructions 22 and files 24.

In this example, the electronic communication device 10 is a mobile cellular telephone and the communications interface 16 is a cellular radio transceiver. However, the invention has application to many other types of electronic device, such as small or hand-held electronic devices, which are capable of storing files in memory, for user access.

Only as many components are illustrated in FIG. 1 as are referred to in the following description. It should be appreciated that additional different components may be used in other embodiments of the invention. For example, although a program processor 12 is illustrated in FIG. 1, any appropriate controller may be used, such as a dedicated processor, e.g. an application specific integrated circuit or similar. The processor 12 is connected to read from and write to the memory 20, to provide control signals to the display 14, to receive control signals from the user input 18, to provide data to the communications interface 16 for transmission and to receive, from the communications interface 16, data that has been received at the device 10. Computer instructions 22 stored in the memory 20 control the operation of the electronic communications device 10 when loaded into the processor 12. The computer program instructions 22 provide the logic and routine that enable the electronic communications device 10 to perform the methods described below.

The computer program instructions may arrive at the electronic communications device 10 via an electromagnetic carrier signal, received through the communications interface 16, or may be copied from a physical entity 26, such as a computer program product, memory device or a recording medium such as a CD-ROM or DVD. A drive 28 or other interface may be provided for reading the contents of a physical entity 26.

Referring to FIG. 2, the device has a housing 30 in which the display 14 is visible. Various user input controls are provided. There is a numeric keypad 32. A control 34 has a plurality of modes of actuation, described below. There are soft keys 36, the significance of which may change from time to time as indicated by appropriate indications in adjacent regions 38 of the display 14.

Each of the soft keys 36 has a single predetermined mode of actuation achieved by a user pressing the key 36. The control 34 may be in the form of a multi-directional key, sometimes termed a joystick, having a total of five predetermined modes of actuation, achieved by rocking the key 34 in one of the four directions indicated by arrows 40, or by pressing the key 34 toward the housing 30. These five predetermined modes of actuation of the key 34 will be referred to below, respectively, as Up, Down, Left, Right and Select.

Accordingly, the soft keys 36 are push switches having a single mode of operation effected by pushing the key 36, whereas the key 34 is designed to allow the user to push the key 34 in a total of five different ways, corresponding to respective predetermined modes of actuation of the key 34, the occurrence of each of which is separately identifiable by the processor 12. The Select mode (pressing the key 34 toward the housing 30) may be soft, having a significance which changes as indicated in an adjacent display region 39.

The display 14 and the user controls 34, 36, as controlled by the processor 12 and software instructions 22, together form a user interface by which a user may control the operation of the device 10.

In addition to storing instructions 22, the memory 20 may contain files 24 of data, text, images, sounds, video, music, links to sources of data by streaming, bookmarks or other user content. The files 24 may be created by operation of the device 10, for example by entering data through the keypad 32 or capturing images or movies using camera functions available in the device 10, or may be received through the drive 28 from an entity 26, or through the communications interface 16 over a mobile cellular telecommunications network.

In this example, the files 24 are catalogued by means of a hierarchical directory structure, one simple example of which can be described with reference to FIG. 3. In FIG. 3, rectangular blocks 42 represent files of user content. Circles represent folders 44 which may contain one or more files 42 and may contain one or more folders 44. Folders may contain only files, or only folders, or a mixture of files and folders. Thus, the uppermost, or top level folder 44a contains a file 42a and a second level folder 44b. The folder 44b contains three third level folders 44c and no files. Two of the folders 44c contain only files 42c. One of the folders 44c contains only a third level folder 44d which contains only files 42d.

Menu structures are preferably created and modified by user instructions, so that they can evolve as the needs of a user change.

The hierarchical nature of the directory structure means that it is possible to navigate from any file or folder to any other file or folder by moving only along the lines of the tree illustrated in FIG. 3, moving up to higher levels or down to lower levels, until reaching a destination file or folder. No jumps are required between files or folders which are not neighbours at the next higher or next lower level of the hierarchical directory structure. Other possibilities are described below.

The process of moving around the directory structure of FIG. 3 is here termed “navigation”. The term “location” is used herein to refer to a position within the directory structure, rather than a physical location within the memory 20. In the example of FIG. 3, a location is synonymous with a folder.

The “contents” of a location are those locations or files at the next lower level below the said location in the directory structure. Thus, the location 44a contains the location 44b and the file 42a.

The remaining drawings illustrate the manner in which the user interface provided by the controls 34, 36 and display 14, in conjunction with the processor 12 under the control of instructions 22, can be used by a user for navigation around the directory structure of FIG. 3 for finding locations or files, or for performing operations on or at files or locations, as will be described. In the example embodiment to be described, user inputs by the controls 34, 36 are interpreted by the processor 12, under the control of the instructions 22, in order to instruct changes to the appearance of the display 14, and the implementation of other functions, as will now be described.

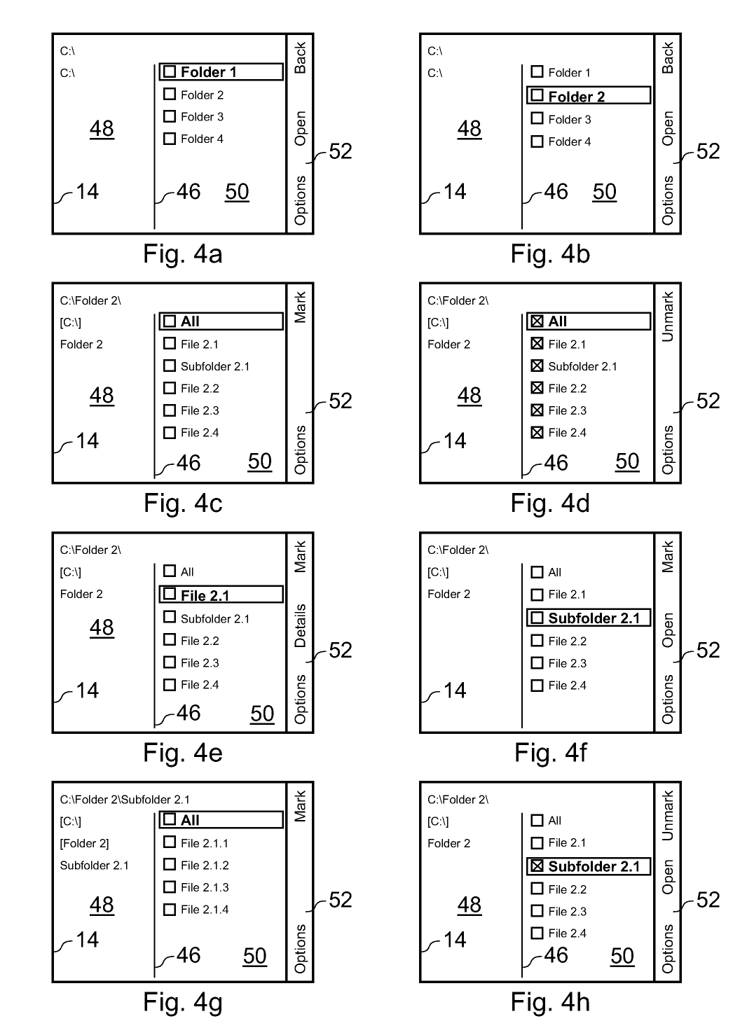

FIG. 4a illustrates the image on the display 14 when navigation of the directory structure begins. The screen of the display 14 is divided vertically at 46. To the left of the split 46, the first screen area 48 shows a path in the directory structure of FIG. 3. In this example, the user is browsing at the topmost level of the directory structure and the path only identifies the location 44a, as c:\. The topmost location 44a represents the currently identified target location from which navigation around the directory structure will commence.

The second screen area 50, to the right of the screen split 46, shows the contents of the currently identified target location (c:\). In this example, based on a different directory structure to that illustrated in FIG. 2, the location c:\ contains four locations, called Folder 1, Folder 2, Folder 3 and Folder 4. One of these locations, Folder 1 is highlighted in the second screen area 50. Highlighting is illustrated in these drawings by a border around the highlighted item, by way of example only. Other means of visually indicating a single location or file could be used, such as colour change, colour contrast, emboldening, flashing or background shading, for example.

The screen of FIG. 4a (and other screens illustrated in the drawings) also has a soft bar 52. In the drawings, the soft bar 52 is illustrated at the right hand side of the display 14, for clarity. When implemented in a device of the type illustrated in FIG. 2, the soft bar 52 will extend across the bottom of the display 14, to provide the regions 38, 39. Accordingly, a word illustrated at the bottom of the soft bar 52 (as illustrated in FIG. 4a) will appear in the left region 38 (as illustrated in FIG. 2); a word appearing at the top of the soft bar 52 (as illustrated in FIG. 4a) will appear in the right region 38 (as illustrated in FIG. 2) and a word in the middle of the soft bar 52 will appear in the region 39 (as illustrated in FIG. 2). The orientation and position of the words, and the orientation of the information in the areas 48, 50 relative to the orientation of the words, may be changed automatically, dependent on the orientation of the device 10. In any particular situation, the orientation and position of words or other information in the areas 48, 50 will be dependent on the language being used.

Words in the soft bar 52 represent commands available to the user by pressing the corresponding soft key 36 or by pressing the key 34 toward the housing 30 (“select”). Comparison of the various drawings from FIG. 4 onwards readily shows that the commands available by the soft keys 36 and by Select will vary at different states of operation of the device, and also that in some states, only two commands are available, selected by the soft keys 36.

The key 34 can be pushed up (toward the display 14) or down (away from the display 14), as has been described above. When in the state of FIG. 4a, the second area 50 is the active area of the display, and these predetermined modes of actuation change the highlighting in the second area 50, to a different location. For example, the Down mode of actuation moves the highlighting from Folder 1 to Folder 2 (FIG. 4b). Another Down actuation would move the highlighting to Folder 3 (not illustrated). An up actuation would move the highlighting back to Folder 1 (as FIG. 4a). Highlighting may be set to wrap around the ends of the list, so that an Up actuation can move from Folder 1 to Folder 4, and a Down actuation can move from Folder 4 to Folder 1. Accordingly, the highlighting can be moved to any of the folders contained in c:\ by repeated use of the Up and/or Down modes of actuation. These modes navigate within the second area 50 by moving up and down the list of locations presented to the user, leaving the current identified target location as c:\.

When a location is highlighted (Folder 2 in FIG. 4b), the Select mode of operation causes c:\ to cease to be the currently identified location (c:\). The highlighted location (Folder 2) becomes the new currently identified location and the display state changes to FIG. 4c. In the second area 50, a new list is presented, being a list of files in Folder 2 (here File 2.1, File 2.2 etc.) and locations in Folder 2 (here Sub-folder 2.1). In addition, a list entry “All” is shown, the significance of which will become apparent below.

The first area 48 has also changed for FIG. 4c. “Folder 2” is now shown below c:\. Thus, the first area 48 is showing the directory path to the currently identified target location (Folder 2) as a list of locations in hierarchical order.

When Folder 2 is initially opened, the All entry is highlighted. Actuation of the Up and Down modes of the joystick 34 provide for navigation up and down the list of contents of Folder 2, in the manner described above in relation to FIGS. 4a and 4b. Thus, by Down actuation, File 2.1 is highlighted in the list (FIG. 4e). A second Down actuation highlights Sub-folder 2.1 (FIG. 4f). Repeated use of the Up and Down modes of actuation allows any member of the list in the second area 50 to be highlighted.

In FIG. 4f, Sub-folder 2.1 (a location) is highlighted. The soft bar 52 shows that Select will implement the Open command, repeating a process similar to that described above in relation to FIGS. 4b and 4c. Thus, pressing Select when in the screen state of FIG. 4f causes Sub-folder 2.1 to become the new currently identified target location. Accordingly, the contents of the Sub-folder 2.1 are now listed in the second area 50 (FIG. 4g) and Sub-folder 2.1 is added to the hierarchical list of locations in the first area 48, so that the full path of locations to the current target location is listed in hierarchical order.

In the examples described above, and illustrated, the contents of a location are identified by their file name in the directory structure. Alternatively, or in addition, the contents could be identified by meta data associated with the file. Examples of meta data include a title, or details of the author, date of creation, type of file or other attribute. Locations may be allocated file attributes (predetermined by the user or during manufacture) and restricted to containing only files which share those attributes. In this example, locations may be identified in the display by showing the attributes, such as the file types contained at the location.

Consideration of the above description, and the corresponding drawings (particularly FIGS. 4b, 4c and 4g) show that while the user is being provided with a full list of locations and files at the current level being navigated (in the second area 50), the user is presented at all times with an overview of where the user is in the folder hierarchy (in the first area 48). The navigation which has been described, to move further down the directory structure, requires only an appropriate combination of Up, Down and Select modes of operation.

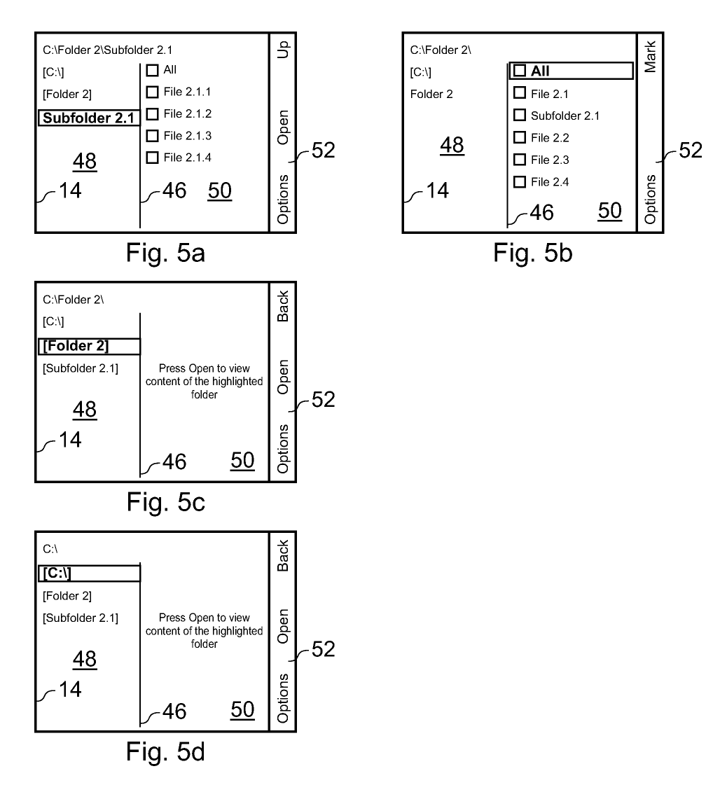

A situation may arise in which a user realises (particularly in the light of the list in the second area 50) that an incorrect choice has been made in the navigation. For example, a user may decide that selecting Sub-folder 2.1 as the currently identified location was inappropriate. The user may therefore wish to navigate up to a higher level of the directory structure. This can be achieved from the display state of FIG. 4g by a Left mode of actuation of the joystick 34. This brings the screen to the state of FIG. 5a. The All entry in Sub-folder 2.1 is no longer highlighted. The Sub-folder 2.1 item in the first area 48 is highlighted. Accordingly, by the Left mode of actuation, the user has navigated from the second area 50 to the first area 48, highlighting the lowermost entry on the list in the first area 48 (which is the currently identified target location). The first area 48 has become the active area of the display. The Up and Down modes of actuation can then be used for navigation in the list in the first area 48, broadly in the manner described above. Thus, the Up mode of actuation moves from the screen state of FIG. 5a to the state of FIG. 5c, with Folder 2 highlighted (the next level above Sub-folder 2.1). A further Up mode of actuation moves the highlighting to c:\ (the uppermost level). As the user navigates through the list, away from the currently identified location (Sub-folder 2.1), the list in the second area 50 is suppressed. This avoids confusion, which might arise by suggesting that the contents of the list 50 are the contents of Folder 2 (FIG. 5c) or Folder c:\ (FIG. 5d).

When a higher level folder is highlighted in the first area 48, such as Folder 2, Select effects the Open command to replace the currently identified location by Folder 2 as the new currently identified location, opening screen 5b to list the contents of Folder 2 in the second area 50 and to update the list in first area 48 to show the path to the currently identified location (c:\ and Folder 2). It can thus be seen that from FIG. 4g, by navigating from the second area 50 to the first area 48 and then navigating within the first area 48 to Folder 2, and opening Folder 2 to reach FIG. 5b, the user has returned to the display state of FIG. 4c.

Returning to FIG. 5a, an alternative option may be provided by the soft keys 36. In this example, the right soft key offers an Up command which changes the currently identified location to the next higher location in the hierarchy, and opens that location, to give the screen state of FIG. 5b.

It can thus be appreciated from the above description that a user can navigate around the directory structure by effecting an appropriate combination of the predetermined modes of actuation, Up, Down, Left and Select. The user is provided with clear information, in the first area 48, as to the current location within the directory structure, and clear information, in the second area 50, as to the contents of the current location. In this example, the currently active area 48, 50 may be indicated by a modified appearance, such as by providing differential brightness for the areas, in order to indicate which of the said areas is currently active.

Once a file has been located by a user, the user may wish to perform an operation on the file, such as to delete, move, copy, send or open it, or to exit the process of navigating the directory structure. In some situations, it may be desirable to execute the same operation on more than one file at the same time. Accordingly, the user interface provides opportunities for the user to identify and “mark” files for operation. For example, commencing at FIG. 4f, the Right mode of actuation of the key 34 marks Sub-folder 2.1, confirmed by displaying a small cross alongside the name of the location (FIG. 4h). A second Right mode of actuation returns to the screen state of FIG. 4f, with the location unmarked. Accordingly, the Right mode of operation toggles the marking of the current highlighted location or file. Marking and unmarking can also be achieved by the right hand soft key, which provides the function Mark in FIG. 4f, and Unmark in FIG. 4h.

FIGS. 4c and 4d illustrate an alternative marking and unmarking scenario. In FIG. 4c, the All entry is highlighted so that the Right mode of actuation, to mark, results in all of the contents of the currently identified target location (Folder 2) being marked (FIG. 4d). Again, marking and unmarking toggles by repeated use of the Right mode of actuation, or the right soft key 36.

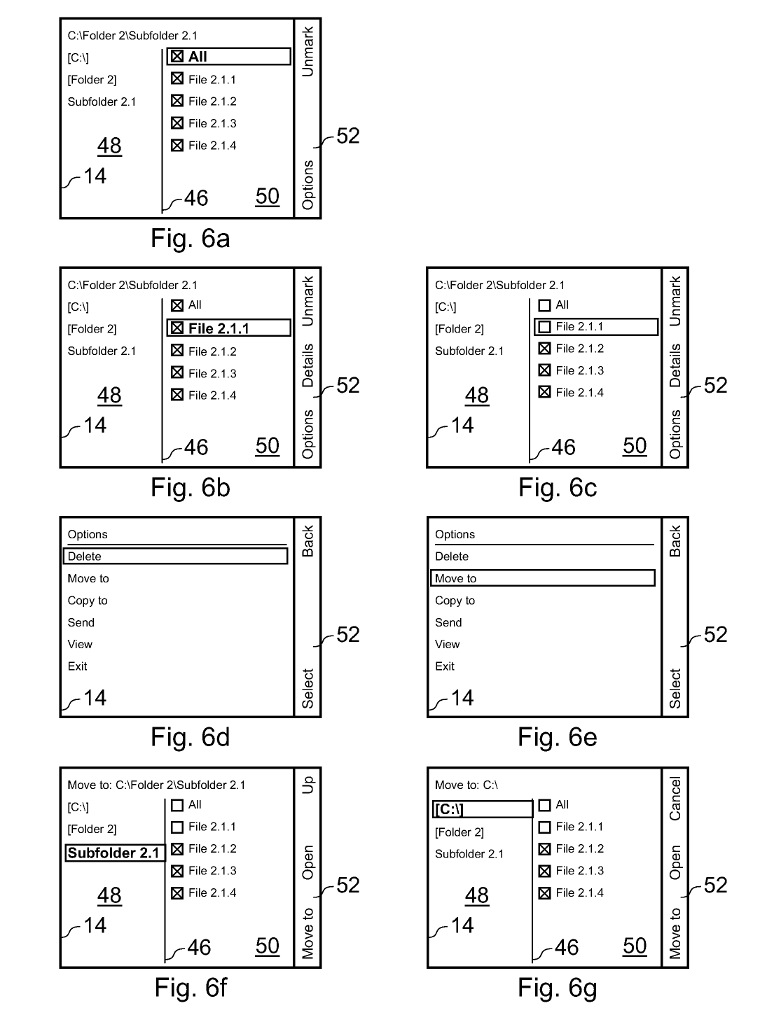

FIG. 4h shows the situation when Folder 2 is the currently identified target location, Sub-folder 2.1 is highlighted and marked. The Select mode of actuation now opens Sub-folder 2.1 (FIG. 6a) and it is to be noted that all of the contents listed in the second area 50 are marked, because Sub-folder 2.1 was marked in FIG. 4h.

FIGS. 6a, 6b and 6c illustrate how the list in the second area 50 can be navigated by the Up and Down modes of actuation, allowing individual files to be highlighted and marked or unmarked (FIGS. 6b and 6c), resulting in a list (FIG. 6c) in which only some of the contents of the currently identified target location (Sub-folder 2.1) are marked.

In FIG. 6c, the left hand soft key 36 offers the Options function which, if opened, takes the user to the screen state of FIG. 6d. The Options function presents a menu (FIG. 6d) of operations, in the form of a list, which the user may navigate up or down using the Up and Down modes of actuation. For example, FIGS. 6d and 6e show the user navigating to the Move To function. The soft bar 52 offers functions Select and Back by use of the soft keys 36. Back returns to the screen from which Options was selected (FIG. 6c). Select begins to implement the highlighted operation (FIG. 6f). It is to be noted that while the Options menu is displayed, the display 14 is no longer split at 46. This is because navigation of the Options menu does not correspond with navigation of the directory structure. However, once the Options menu closes (by implementing Select or Back), the split display is restored (FIG. 6c or 6f).

The Options menu illustrated in FIGS. 6d and 6e has menu items for deleting a file (Delete), moving a file (Move To), copying a file (Copy To), sending a file (Send), opening or viewing a file (View) and exiting the Options menu (Exit). Other menu items could be included in the Options menu, instead of, or in addition to those shown. For example, there may be items for renaming a file, or other content specific options, such as viewing an image or text file, playing an audio or video file, loading a file which is accessible by a streaming link or bookmarking a file for easy location.

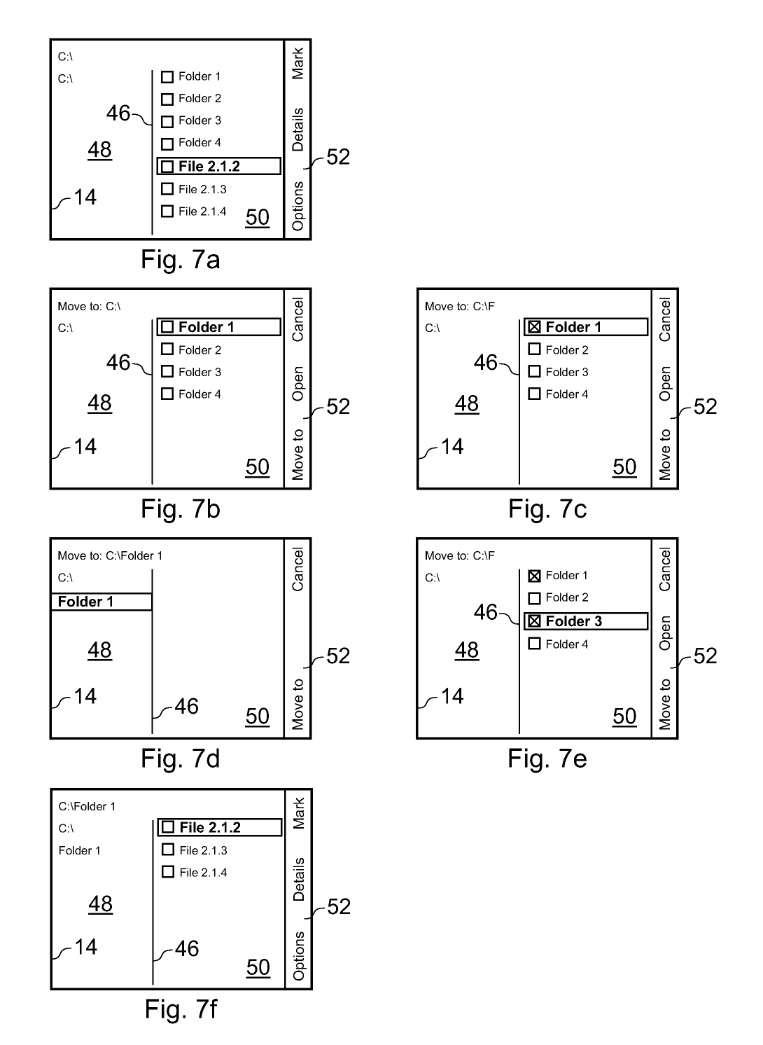

The operations Move To and Copy To are operations which require the user to identify another location to which the file is to be moved or copied. This is achieved, in this embodiment, by navigation in the manner described above, commencing at the screen state of FIG. 6f. In FIG. 6f, the currently identified target location is highlighted in the first area 48. This allows the user to navigate the list in the area 48 to the appropriate level, for example the uppermost level c:\, by using the Up and Down modes of operation. The user has navigated to c:\, in FIG. 6g. At this state, the soft bar 52 offers the Move To function by the left soft key 36, or the Open function by Select mode of actuation of the key 34. The Open function makes c:\ the new currently identified target location, replacing the list on the second area 50 with a list of the contents of c:\ (FIG. 6a), and replacing the path listed in the first area 48 in FIG. 6g, with the path (c:\) of the new currently identified target location. This is the screen state of FIG. 7b. The user can continue to navigate around the directory structure in the manner described above, in order to find the desired target location for moving the marked file or files. For example, the Select mode of operation used at screen state FIG. 7b enters Folder 1 (currently empty) as shown in FIG. 7d, updating the list in the left area 48 to show the new currently identified target location. Using the left soft key 36 to effect the Move To function, the previously marked files (FIG. 6c) are moved to Folder 1 (FIG. 7f). (In the event that the user had selected the Copy To function at screen state FIG. 6d, the left soft key 36 would offer the Copy To function, rather than the Move To function).

An operation of marking can also be effected when finding a target location for movement of a file or files, as illustrated in FIGS. 7c and 7e. Commencing at the screen state of FIG. 7b, the Right mode of operation marks Folder 1 (the currently highlighted folder) to give the screen state of FIG. 7c. Navigation up and down the list in the right area 50 allows Folder 3 to be marked by the Right mode of operation, thus leaving Folder 1 and Folder 3 both marked (FIG. 7e). Selecting the Move To function causes the marked files (FIG. 6c) to be moved to both marked folders, Folder 1 and Folder 3. The screen state changes to the state of FIG. 7f, showing the contents of the first folder listed in the right area 50 of FIG. 7e.

Returning to FIG. 6g, in the event that a location above the currently identified target location is highlighted (in this example c:\ is highlighted), the Move To function results in the highlighted location becoming the new currently identified location, and the marked files (FIG. 6c) being moved to that location (FIG. 7a).

The operations of Move To and Copy To may be further simplified in the event that files and locations are associated with meta data. For example, selection of Move To or Copy To may result in the user being prompted to confirm that the current file is to be moved or copied to a location appropriate to the file, in view of the meta data attributes of the file. For example, a location containing image files may be suggested if the meta data attributes indicate that the file is an image file.

In a further example of the use of meta data, the user interface may allow the user to edit the meta data. When the edit is complete, the user may be prompted to move the file to a location appropriate to the edited meta data.

It can thus be understood from the above examples that navigation around a directory structure, in order to identify, locate, copy, move or otherwise deal with the contents of the directory structure, is provided for the user in a manner which is expected to be clear to the user (in view of the information provided by the split display) and easily effected even with the limited controls available on a small device, such as a mobile telephone, by repeated use of a small number of predetermined modes of actuation (particularly Up, Down, Left and Select of a multi-functional actuator such as a joystick device).

In the illustrated examples, the location of the split 46 is fixed. Alternatively, the location of the split 46 may be dynamic. For example, the location of the split 46 may be moved to increase the size of one of the areas 48, 50 and allow more information to be displayed in that area. Moving the split 46 allows the sizes, or relative sizes, of the first and second screen areas to be dynamic. When the size of the first screen area 48 is reduced, it is convenient to truncate directory path information shown in the first screen area 48. The directory path information may be truncated by omitting higher order information. Thus, path information is omitted, beginning with information about the highest level of the hierarchy, and omitting information from progressively lower hierarchy levels, until the information has been sufficiently truncated for convenient viewing. In this example, the truncation direction will be language dependent. Thus, in Western languages, truncation will be from the left, whereas in other languages, such as Middle Eastern languages, truncation may be from the right. The split 46 may be vertical, as shown, or horizontal, or at another angle. The position of the split 46 may be dependent on the orientation of the device 10.

In the illustrated examples, the directory structure has been described as hierarchical, with navigation taking place only between locations at the next lower or next higher hierarchical level. The directory has also been described as containing files at the locations. Other arrangements are possible. The directory locations may contain meta data relating to files, together with a reference to the actual location of the file. This allows references to a single file to appear at multiple locations, without duplicating the file. For example, a reference may be contained in a location relating to the author of the file, and in another location relating to the content. In this example, navigation may be allowed at the same level of the hierarchy, such as to find other files by the same author, or other files with similar content.

The aspects of the disclosed embodiments have been described above in relation to a mobile telephone. It should be appreciated that embodiments may be implemented in other devices, including other small, hand-held devices such as PDAs (personal digital assistants). Although embodiments have been described in the preceding paragraphs with reference to various examples, it should be appreciated that modifications to the examples can be made without departing from the scope of the invention as claimed.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. An apparatus configured to store files in a directory structure, comprising a user interface including a display and at least one user control, the user interface being configured to receive user instructions to navigate around the directory structure to identify target files and target locations, and wherein, during navigation by a user, the user interface provides at least a first screen area for showing a directory path to a currently identified target location, and a second screen area for showing the contents of a currently identified target location, wherein the user control has a plurality of predetermined modes of actuation, there being at least one predetermined mode of actuation for navigating within a said area, and at least one predetermined mode of actuation for navigating between said areas.

2. An apparatus according to claim 1, wherein the first screen area, in use, displays a directory path as a list of locations in hierarchical order.

3. An apparatus according to claim 1, wherein the second screen area, in use, displays the contents as a list.

4. An apparatus according to claim 2, wherein respective predetermined modes of actuation provide for navigation up and down a list.

5. An apparatus according to claim 4, wherein the Up and Down modes are provided by respective modes of actuation of a multi-mode control member.

6. An apparatus according to claim 1, wherein a further predetermined mode of actuation provides for selection of a location as the currently identified location.

7. An apparatus according to claim 1, wherein at least one further predetermined mode of actuation is provided for navigation between the areas.

8. An apparatus according to claim 1, wherein respective further predetermined modes provide for navigation in respective senses between the areas.

9. An apparatus according to claim 1, wherein, when a user has navigated to a file, a still further predetermined mode of actuation provides for at least one operation to be performed on the said file.

10. An apparatus according to claim 1, wherein an additional predetermined mode of actuation provides for the currently identified target location to be replaced as the target location by a location at a higher level of the hierarchy.

11. A method comprising providing at least one user control having a plurality of predetermined modes of actuation, receiving user instructions to navigate around a directory structure storing files in a device, to identify target files and target locations, and wherein, at least a first screen area is provided for showing a directory path to a currently identified target location, and a second screen area is provided for showing the contents of a currently identified target location, and wherein at least one predetermined mode of actuation results in navigation within a said area, and at least one predetermined mode of actuation results in navigation between said areas.

12. A method according to claim 11, wherein a directory path is displayed on the first screen area as a list of locations in hierarchical order.

13. A method according to claim 11, wherein the contents are displayed in the second screen area as a list.

14. A method according to claim 12, wherein respective predetermined modes of actuation provide for navigation up and down a list.

15. A method according to claim 14, wherein the Up and Down modes are provided by respective modes of actuation of a multi-mode control member.

16. A method according to claim 11, wherein a further predetermined mode of actuation provides for selection of a location as the currently identified location.

17. A method according to claim 11, wherein at least one further predetermined mode of actuation is provided for navigation between the areas.

18. A method according to claim 11, wherein respective further predetermined modes provide for navigation in respective senses between the areas.

19. A method according to claim 11, wherein, when a user has navigated to a file, a still further predetermined mode of actuation provides for at least one operation to be performed on the said file.

20. A method according to claim 11, wherein an additional predetermined mode of actuation provides for the currently identified target location to be replaced as the target location by a location at a higher level of the hierarchy.

21. A computer program product comprising program instructions stored in a memory for receiving user instructions by actuation of a user control having a plurality of predetermined modes of actuation, to navigate around a directory structure storing files in a device, to identify target files and target locations, and to provide a first area on a screen for showing a directory path to a currently identified target location, and a second area on the or a screen for showing the contents of the currently identified target location, and wherein at least one predetermined mode of actuation results in navigation within a said area, and at least one predetermined mode of actuation results in navigation between said areas.
